(19) United States
(12) Patent Application Publication
(10) Pub. No.: US 2024/0357503 A1
(43) Pub. Date: Oct. 24, 2024

(54) IN-VEHICLE COMMUNICATION DEVICE, COMMUNICATION MANAGEMENT SERVER, PROGRAM, COMMUNICATION MANAGEMENT SYSTEM, AND COMMUNICATION MANAGEMENT METHOD

(71) Applicant: DENSO CORPORATION, Kariya-city (JP)

(72) Inventor: Yuki ITO, Kariya-city (JP)

(21) Appl. No.: 18/755,146

(22) Filed: Jun. 26, 2024

Related U.S. Application Data
(63) Continuation of application No. PCT/JP2022/047459, filed on Dec. 22, 2022.

(30) Foreign Application Priority Data
Dec. 28, 2021 (JP) 2021-214979

(51) Int. Cl. H04W 52/02

(52) U.S. Cl. CPC H04W 52/0238; H04W 52/0277

(57) ABSTRACT

An in-vehicle communication device is used with a target vehicle and includes a communication device and a power supply controller. The communication device includes a plurality of communication modules, each connecting with one of discrete communication lines. When the target vehicle is parked, the power supply controller works to analyze states of communication in the communication lines to select at least one of the communication lines which is available as an activation line used for remote activation of the in-vehicle communication device made by a communication management server. The power supply controller also works to place a selected one of the communication modules which corresponds to the activation line in a standby mode in which the selected communication module is kept powered on and enabled only to receive an activation request signal from the communication management server. The power supply controller also places the remaining communication modules in a power-off mode.

### CROSS REFERENCE TO RELATED DOCUMENT

The present application claims the benefit of priority of Japanese Patent Application No. 2021-214979 filed on Dec. 28, 2021, the disclosure of which is incorporated in its entirety herein by reference.

### TECHNICAL FIELD

This disclosure relates generally to an in-vehicle communication device, a communication management server, a program, a communication management system, and a communication management method.

### BACKGROUND ART

Devices are known which have a power-saving mode (i.e., sleep mode) in which at least one of functions thereof is deactivated to reduce consumption of electrical power therein. Techniques for remotely returning or awakening devices from the power-saving mode are also known. For instance, international publication WO2011/048658 teaches an information processor which is equipped with a plurality of communication interfaces and records identifiers for the communication interfaces in a storage in order to awaken the device from the power-saving mode when an activation packet is received using any one of the communication interfaces. As long as an identifier contained in the activation packet matches that retained in the storage regardless of whether the activation packet was received through any of the communication interfaces, the information processor is awakened from the power-saving mode.

### PRIOR ART DOCUMENT

### Patent Literature

FIRST PATENT LITERATURE: International Publication WO2011/048658

### SUMMARY OF THE INVENTION

The inventor of this application has studied the above techniques and detected the fact that the use of the above techniques with an in-vehicle communication device installed in a vehicle encounters the following drawbacks. Usually, cellular communication lines vary in state of communication according to in-service areas or time period, which may result in a failure in achieving remote activation of the in-vehicle communication device in some areas where the vehicle is parked. In a case where the in-vehicle communication device is equipped with a plurality of communication modules, when the communication modules are all brought to the power-saving mode, it will be difficult to adequately reduce a consumed amount of electrical power in the in-vehicle communication device, which may lead to a risk that a battery installed in the vehicle may run out.

It is an object of this disclosure to provide an in-vehicle communication device, a communication management server, a communication management system, and a program which are capable of keeping at least one of communication modules in a remote activable mode and minimizing a consumed total amount of electrical power in the communication modules.

According to one aspect of this disclosure, there is provided an in-vehicle communication device for use with a target vehicle which comprises: (a) a communication device which includes a plurality of communication modules each for a respective one of a plurality of discrete communication lines; and (b) a power supply controller which, when the target vehicle is stopped, works to analyze states of communication in the communication lines to select at least one of the communication lines which is available as an activation line used for remote activation of the in-vehicle communication device made by a communication management server. The power supply controller also works to place a target communication module that is one of the communication modules which corresponds to the activation line in a standby mode in which the target communication module is kept powered on and enabled only to receive an activation request signal from the communication management server. The power supply controller also places the remaining communication modules other than the target communication module in a rest mode in which the remaining communication modules are kept powered off.

According to the second aspect of this disclosure, there is provided a communication management server for an in-vehicle communication device which includes a communication device which includes a plurality of communication modules each for a respective one of a plurality of discrete communication lines and a power supply controller which, when a target vehicle is stopped, works to analyze states of communication in the communication lines to select at least one of the communication lines which is available as an activation line used for remote activation of the in-vehicle communication device. The power supply controller also works to place a target communication module that is one of the communication modules which corresponds to the activation line in a standby mode in which the target communication module is kept powered on and enabled only to receive an activation request signal. The power supply controller also places the remaining communication modules other than the target communication module in a rest mode in which the remaining communication modules are kept powered off. The communication management server comprises: (a) an output device which outputs an activation line candidate to the in-vehicle communication device, the activation line candidate being a candidate for the activation line and representing one of the communication lines which is higher in stability in state of communication than the other; and (b) a remote activator which transmits the activation request signal using the activation line to remotely activate the in-vehicle communication device.

According to the third aspect of this disclosure, there is provided a communication management system comprising an in-vehicle communication device and a communication management server. The in-vehicle communication device includes a communication device and a power supply controller. The communication device includes a plurality of communication modules each for a respective one of a plurality of discrete communication lines. When the target vehicle is parked, the power supply controller works to analyze states of communication in the communication lines to select at least one of the communication lines which is available as an activation line used for remote activation of the in-vehicle communication device. The power supply controller also works to place a target communication module that is one of the communication modules which corresponds to the activation line in a standby mode in which the target communication module is kept powered on and enabled only to receive an activation request. The power supply controller also places the remaining communication modules other than the target communication module in a rest mode in which the remaining communication modules are kept powered off. The communication management server which is communicable with the in-vehicle communication device using a network and includes an output device and a remote activator. The output device works to output an activation line candidate to the in-vehicle communication device. The activation line candidate is a candidate for the activation line and represents one of the communication lines which is higher in stability in state of communication than the other. The remote activator transmits the activation request signal using the activation line to achieve the remote activation of the in-vehicle communication device.

According to the fourth aspect of this disclosure, there is provided a communication management method which comprises: (a) outputting a signal to an in-vehicle communication device installed in a target vehicle from a communication management server communicable with the in-vehicle communication device using a network, the in-vehicle communication device including a communication device equipped with a plurality of communication modules each for a respective one of a plurality of discrete communication lines, the signal indicating at least one of the communication lines which is higher in stability in state of communication than the other; (b) analyzing the signal, when the target vehicle is stopped, to determine the at least one of the communication lines which is higher in stability in state of communication than the other as an activation line used for remote activation of the in-vehicle communication device made by the communication management server; (c) placing a target communication module that is one of the communication modules which corresponds to the activation line in a standby mode in which the target communication module is kept powered on and enabled only to receive an activation request from the communication management server; (d) placing the remaining communication modules other than the target communication module in a rest mode in which the remaining communication modules are kept powered off; and (e) outputting the activation request through the communication management server to the in-vehicle communication device using the activation line to achieve the remote activation of the in-vehicle communication device.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a schematic view which illustrates a structure of a communication management system according to the first embodiment in this disclosure;

FIG. 2 is a block diagram which illustrates an electrical structure of an in-vehicle communication device;

FIG. 3 is a block diagram which illustrates an electrical structure of a communication management server;

FIG. 4 is a view which demonstrates a change in mode of operation of communication modules;

FIG. 5 is a block diagram which illustrates a functional structure of a communication management system according to the first embodiment;

FIG. 6 is a view which shows a first example of a sequence of operations of a communication management system;

FIG. 7 is a view which shows a second example of a sequence of operations of a communication management system;

FIG. 8 is a view which illustrates a table for used in management of discrete data collected from vehicles;

FIG. 9 is a schematic view which shows an example of statistic data obtained from a database;

FIG. 10 is a flowchart of a program executed by an in-vehicle communication device to perform a standby-mode entry task;

FIG. 11 is a flowchart of a sequence of logical steps performed by an in-vehicle communication device in response to a trigger signal;

FIG. 12 is a flowchart of a program executed to perform an activation task;

FIG. 13 is a flowchart of a sequence of steps of a communication-line change task;

FIG. 14 is a flowchart of a sequence of steps of a communication-line change task in a second example;

FIG. 15 is a flowchart of a sequence of steps performed by a communication management server in response to a trigger signal;

FIG. 16 is a flowchart of a sequence of steps executed to perform a standby-mode entry assistance task;

FIG. 17 is a view which shows an activation line table;

FIG. 18 is a flowchart of a sequence of steps executed to perform a remote activation task;

FIG. 19 is a flowchart of a sequence of steps executed by a communication management server to perform a communication state monitoring task;

FIG. 20 is a graph which demonstrates a variation in state of communication;

FIG. 21 is schematic view which illustrates a structure of a communication management system according to the second embodiment in this disclosure;

FIG. 22 is a block diagram which illustrates a functional structure of a communication management system according to the 15 second embodiment;

FIG. 23 is a flowchart of a sequence of steps executed to perform a standby-mode entry task according to the second embodiment;

FIG. 24 is a schematic view which illustrates a structure of a communication management system according to the third embodiment in this disclosure;

FIG. 25 is a block diagram which illustrates a functional structure of a communication management system according to the third embodiment in this disclosure;

FIG. 26 is a flowchart of a sequence of steps executed to perform a standby-mode entry task according to the third embodiment; and

FIG. 27 is a flowchart of a sequence of steps executed to perform a remote activation task according to the third embodiment.

### MODE FOR CARRYING OUT THE INVENTION

Embodiments of this invention will be described below with reference to the drawings.

### First Embodiment

A communication management system according to the first embodiment in this disclosure will be described below.

### Communication Management System

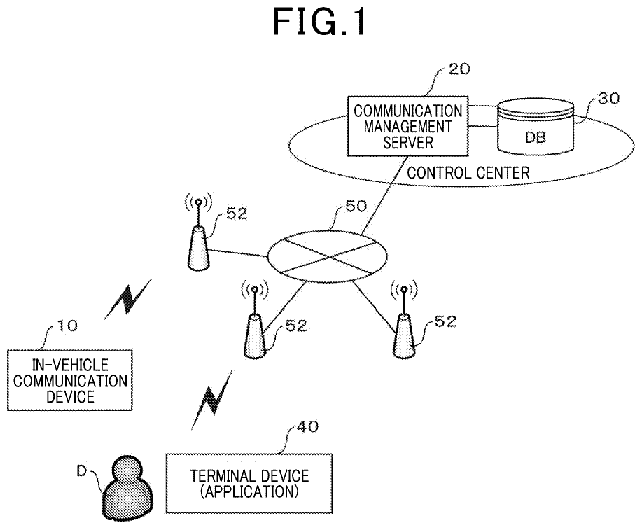

The communication management system in this disclosure, as illustrated in FIG. 1, includes the in-vehicle communication devices 10 installed in a vehicle (which will also be referred to below as a target vehicle), the communication management server 20 installed in a control center, the database 30 connecting with the communication management server 20, and the terminal device 40 operated by the user D. The vehicle may be an autonomous vehicle or a private passenger vehicle manually operated by the user D.

The in-vehicle communication devices 10 and the terminal device 40 are connected to the network 50 that is a public network, such as an internet, through the wireless base station 52. The in-vehicle communication devices 10 wirelessly communicates with the communication management server 20 connecting with the network 50. The communication management server 20 and the database 30 are connected together through, for example, a LAN and communicate with each other in a wired or a wireless mode.

The communication management system in this embodiment is designed to remotely restart or activate the in-vehicle communication devices 10 placed in a power-saving mode (also called low-power mode or sleep mode) using the communication management server 20. The communication management server 20 works to manage operations of a plurality of in-vehicle communication devices 10. Specifically, the communication management server 20 controls the operation of each of the in-vehicle communication devices 10 even after entering the power-saving mode to keep each of the in-vehicle communication devices 10 in a remote activatable mode (i.e., remote restartable mode).

For the sake of simplicity of illustration, the drawings illustrate one in-vehicle communication device 10, one communication management server 20, one database 30, and one terminal device 40, but however, the number of each part may be optional. In terms of construction of the database 30, a plurality of vehicles, that is, a plurality of in-vehicle communication devices 10 are expected to be present. The communication management system may also include a plurality of communication management servers 20, a plurality of databases 30, and a plurality of terminal devices 40.

The locations of the communication management server 20 and the database 30 are not limited to the illustrated ones, but may alternatively be installed in a cloud. The communication management system may exclude the terminal device 40. In this embodiment, the terminal device 40 stores a remote activation application program. The communication management server 20 is responsive to activation instructions outputted from the terminal device 40 to make an activation request to each of the in-vehicle communication devices 10, but however, the communication management server 20 may determine by itself whether the activation request should be made to each of the in-vehicle communication devices 10.

### Electrical Structure of Each Device

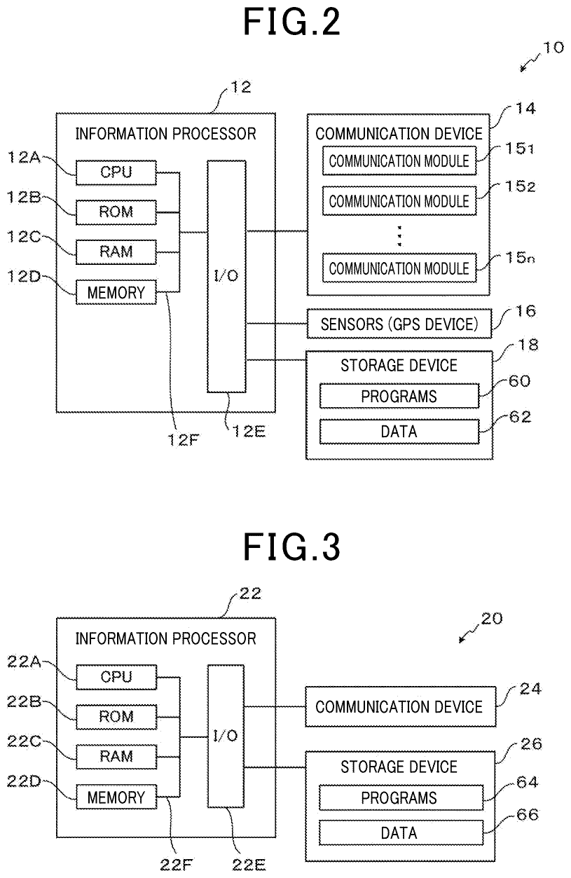

An example of an electrical structure of the in-vehicle communication devices 10 will be described below. The in-vehicle communication devices 10 is, as illustrated in FIG. 2, implemented by an electronic control unit (ECU) and includes the information processor 12 made of a computer, the communication device 14, the sensors 16, and the storage device 18. The information processor 12 includes a CPU (Central Processing Unit) 12A, a ROM (Read Only Memory) 12B, a RAM (Random Access Memory) 12C, the non-volatile memory 12D, and the input and output (I/O) device 12E which are connected together using the bus 12F. The communication device 14, the sensors 16, and the storage device 18 are connected to the I/O device 12E.

The CPU 12A reads a program from the storage device 18 and executes the program using the RAM 12C as a workspace. Specifically, the CPU 12A works to control operations of devices connected to the I/O device 12E and arithmetic operations according to the program stored in the storage device 18.

The sensors 16 may include a GPS (Global Positioning System) working to derive a present position of the target vehicle, an in-vehicle camera working to capture an image of a surround view, such as a frontal or side view of the target vehicle, a millimeter-wave radar detecting obstacles around the target vehicle, a LIDAR (Light Detection and Ranging/Laser Imaging Detection and Ranging) detecting obstacles around the target vehicle, and a microphone detecting ambient sound around the target vehicle. The communication management system in this embodiment uses the GPS (Global Positioning System) 16 working to derive a present position of the target vehicle and a standard time.

The communication device 14 is used as a communication interface to achieve communication with an external device (i.e., the communication management server 20) using wide-area wireless communication standards, such as Ethernet (trade mark), FDDI, Wi-Fi (trade mark), LTE (Long Term Evolution), 4G or 5G. The communication device 14 includes a plurality of communication modules 15₁ to 15ₙ which are controllable independently from each other. The communication modules 15₁ to 15ₙ are provided each connectable with one of available telecommunications carriers. In other words, the communication modules 15₁ to 15ₙ use communication lines which are discrete or different from each other. In the following discussion, the communication modules 15₁ to 15ₙ will generally be referred to as the communication modules 15.

The storage device 18 is made of an external storage memory other than a HDD (Hard Disc Drive). The storage device 18 stores a variety of programs or data therein. In this embodiment, the storage device 18 retains therein the programs 60 and data 62 for use in performing a standby-mode entry task, an activation task, and a communication-line change task which will be described later in detail.

The in-vehicle communication devices 10 installed in private passenger vehicles may be equipped with user interfaces, i.e., HMIs (Human Machine Interfaces). In a case where the in-vehicle communication devices 10 are installed in self-driving vehicles, they may be equipped with vehicle controllers working to control mechanisms mounted in the vehicles to achieve an autonomous driving mode or a remote control mode.

An example of an electrical structure of the communication management server 20 will be described below. The communication management server 20, as illustrated in FIG. 3, includes the information processor 22, the communication device 24, and the storage device 26. The information processor 22 serves as a server computer and includes the CPU 22A, the ROM 22B, the RAM 22C, the non-volatile memory 22D, and the input and output (I/O) device 22E which are mutually connected using the bus 22F. The communication device 24 and the storage device 26 are connected to the input and output device 22E.

The information processor 22 and the communication device 24 are identical in structure with those installed in the in-vehicle communication devices 10, and explanation thereof in detail will be omitted here. The storage device 26 is made of an external storage memory other than a HDD (Hard Disc Drive). The storage device 26 stores a variety of programs or data therein. In this embodiment, the storage device 26 retains therein the programs 64 for performing a standby-mode entry assistance task, a remote activation task, and a communication state monitoring task which will be described later in detail.

The terminal device 40 is equipped with an operation unit working as a user interface. Other arrangements of the terminal device 40 are identical with those in the communication management server 20, and explanation thereof in detail will be omitted here.

### Functional Structure of System

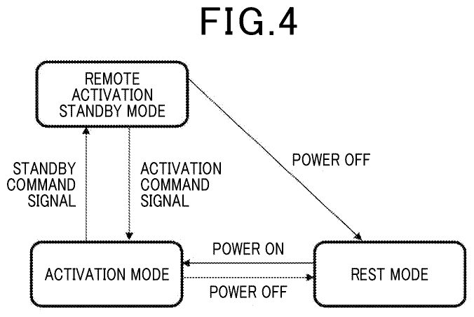

A functional structure of the communication management system will be described below with reference to FIGS. 4 to 7.

First, a transition of operation modes of each of the communication modules 15 will be described below. The communication module 15 is selectively operable in a remote activation standby mode (which will merely be referred to as a standby mode), an activation mode (also called a start mode), and a rest mode. The communication module 15 is controlled in operation by the information processor 12. Specifically, when receiving input of a standby command signal, the communication module 15 changes from the activation mode to the standby mode. When receiving input of an activation command signal, the communication module 15 changes from the standby mode to the activation mode. When powered off, the communication module 15 enters the rest mode. When powered on, the communication module 15 is placed in the activation mode.

The remote activation standby mode is to establish a standby state of the communication module 15 in response to an activation request made by the communication management server 20 to wait for the activation mode. In the standby mode (i.e., the remote activation standby mode), the communication module 15 is kept powered on, but placed in the power-saving mode in which it is impossible to perform data communication. The activation mode is a wake-up mode of the communication module 15 in which the communication module 15 is powered on, and it is possible to perform data communication. The rest mode is a power-off mode of the communication module 15 in which the communication module 15 is powered off, and it is impossible to perform data communication.

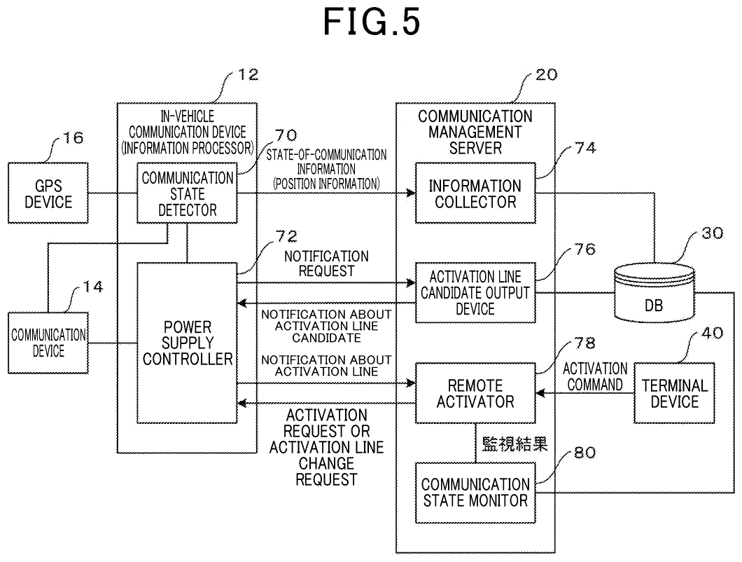

The functional structure of the communication management system will be described below with reference to FIG. 5. Each of the in-vehicle communication devices 10 includes the communication state detector 70 and the power supply controller 72. The communication state detector 70 and the power supply controller 72 are realized by executing programs in the in-vehicle communication device 10.

The communication state detector 70 works to measure states of communication in the communication lines used in the communication device 14. Specifically, the communication state detector 70 acquires one of parameters from the communication device 14 which indicates the states of communication in the communication lines in the form of radio field strengths measured by the communication device 14. The parameter indicating the state of communication in each of the communication lines will be described later in detail. The communication state detector 70 obtains the present position of the target vehicle using the GPS device 16. The power supply controller 72 works to control switching of the states of the communication modules 15 installed in the communication device 14 and also to control supply of electrical power to each of the communication modules 15.

In the power-saving mode, the power supply controller 72 brings one of the communication modules 15 which connects with a corresponding one of the communication lines (which will also be referred to as an activation line) used in achieving the remote activation of the communication module 15 to the standby mode. The power supply controller 72 also brings the remaining communication modules 15 to the rest mode. The power supply controller 72 may use two or more of the communication lines as the activation lines. In other words, the power supply controller 72 may bring two or more of the communication modules 15 to the standby mode and inform the communication management server 20 of the activation lines.

The communication management server 20 includes the information collector 74, the activation line candidate output device 76, the remote activator 78, and the communication state monitor 80. The information collector 74, the activation line candidate output device 76, the remote activator 78, and the communication state monitor 80 are realized by executing programs, as will be described later in detail, by the communication management server 20.

The information collector 74 works to gather information about the state of communication (which will also be referred to as communication-state information) at a parking area from each of the in-vehicle communication devices 10 and stores it in the database 30. The activation line candidate output device 76 analyzes the information stored in the database 30 to select a candidate(s) for the activation line (which will also be referred to as an activation line candidate). The activation line candidate output device 76 works to output the selected activation line candidate to the in-vehicle communication devices 10.

The communication-state information includes a parameter indicating the state of communication. Such a parameter may include a parameter of radio field strength, congestion, throughput, or latency. In this embodiment, one of these parameters is used as an index to calculate a degree of stability of communication in the communication line. The congestion represents a measure of communication traffic. The throughput represents network throughput referring to a data traffic per unit time. The latency represents a measure of time delay experienced by the in-vehicle communication device 10. For instance, in use of the congestion or the latency as the index, the stability in the communication line is expressed by a communication rate.

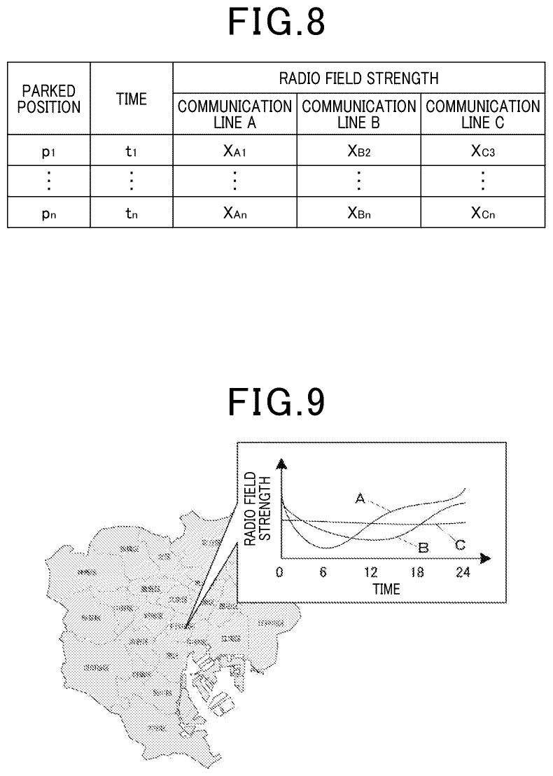

Discrete parameters, as demonstrated in FIG. 8, which represent, for example, a parked or stopped position of the target vehicle, a time, and states of communications (e.g., radio field strengths) in all available ones of the communication lines (i.e., the communication lines A, B, and C demonstrated in the drawings) are collected from each of the in-vehicle communication devices 10 and stored in sequence in the form of a table in the database 30. A number of such data are accumulated in the database 30 and thereby enabled as statistical data. For instance, the information collector 74, as illustrated in FIG. 9, may be designed to obtain, from the database 30, a representative value (e.g., an average value, a maximum value, or a minimum value) of a parameter representing the state of communication in a specified area in each time period.

FIG. 9 illustrates an example of a predicted change in radio field strength in a 24-hour period in Chiyoda-ku, Tokyo in Japan. The communication line A is low in radio field strength, that is, unstable in communication, in the morning, but becomes high in radio field strength, that is, stable in communication, in the afternoon. In this way, the state of communication in each of the communication lines usually varies depending upon congestion at a base station. Such a variation tendency may be predicted or calculated using statistical data. In the event of a temporal communication failure, the above-described data about an area where a communication failure is occurring may be accumulated to derive a tendency of variation in state of communication until the communication is recovered in real time.

The remote activator 78 is responsive to an activation command from the terminal device 40 to remotely activate the communication modules 15 of the vehicle communication device 10 using the specified activation line. When there are two or more activation lines, the remote activator 78 remotely activate the communication modules 15 using at least one of the activation lines. The communication state monitor 80 analyzes data stored in the database 30 to monitor the state of communication in the activation line(s), as specified by the in-vehicle communication device 10. When the state of communication in the specified activation line(s) is expected to be lowered, the remote activator 78 requests the in-vehicle communication device 10 to change the specified activation line to another.

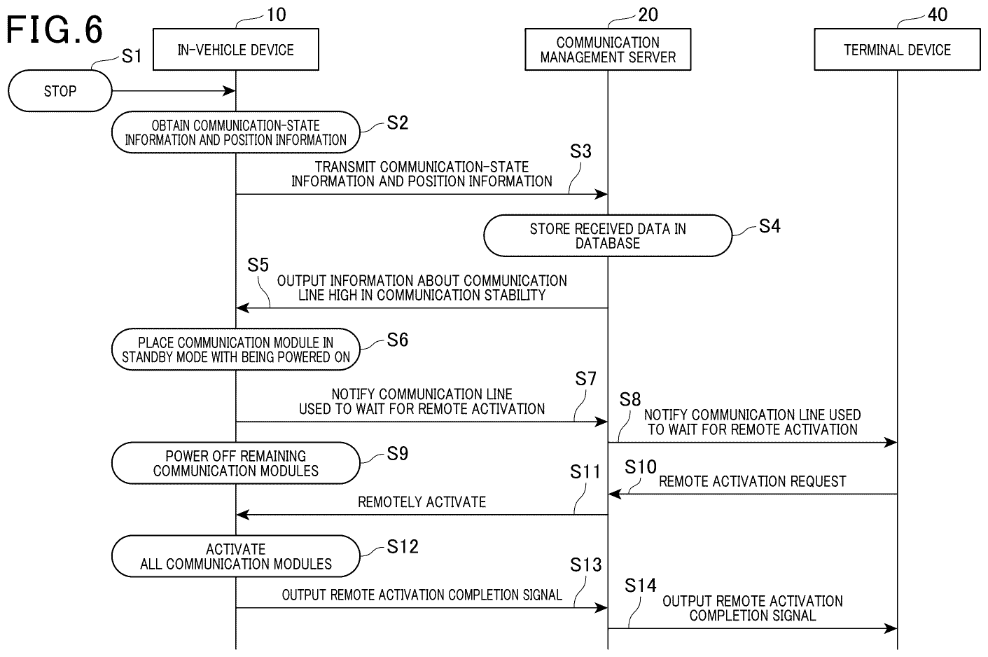

A sequence of logical steps or task executed by the communication management system will be described below with reference to FIG. 6. When the target vehicle is stopped or parked, so that the in-vehicle communication device 10 stops moving, the communication management system starts executing the task (S1). First, the communication state detector 70 of the in-vehicle communication device 10 obtains the states of communication in the communication lines from the communication device 14 and also acquires information about the present position of the target vehicle from the GPS device 16 (S2). The communication state detector 70 then outputs the obtained communication-state information and the obtained position information to the communication management server 20 (S3).

The information collector 74 installed in the communication management server 20 links the communication-state information and the position information to the time and stores it in the database 30 (S4). The activation line candidate output device 76 analyzes the position information to determine an area where the target vehicle is parked and then refer to the database 30 to obtain information about one of the communication lines which is higher in stability in communication than the other using a relation between the determined area and the present time zone and outputs the information to the in-vehicle communication device 10 (S5). In other words, the in-vehicle communication device 10 is notified of a candidate for the activation line.

The power supply controller 72 of the in-vehicle communication devices 10 determines the candidate for the activation line, as specified by the activation line candidate output device 76, that is, one of the communication lines which is highest in stability in communication as the activation line. The power supply controller 72 then keeps one of the communication modules 15 which corresponds or connects with the activation line powered on and places it in the standby mode (S6). The power supply controller 72 notifies the communication management server 20 of which communication line is used to wait for remotely activating the in-vehicle communication device 10 (S7). Similarly, the communication management server 20 notifies the terminal device 40 of which communication line is used to wait for remotely activating the in-vehicle communication device 10 (S8). The power supply controller 72 turns off the remaining communication modules 15 and place them in the rest mode (i.e., power-off mode) (S9). The in-vehicle communication device 10 then enters the power-saving mode and wait for being remotely activated by the communication management server 20.

The terminal device 40 outputs an activation command to the communication management server 20 (S10). When receiving the activation command from the terminal device 40, the remote activator 78 installed in the communication management server 20 transmits an activation request signal to the in-vehicle communication device 10 using the activation line (S11). The power supply controller 72 installed in the in-vehicle communication device 10 works to place all the communication modules 15 in the activation mode (S12) and transmits a remote activation completion signal to the communication management server 20 (S13). The communication management server 20 also notifies the terminal device 40 of completion of remote activation of the in-vehicle communication device 10 (S14).

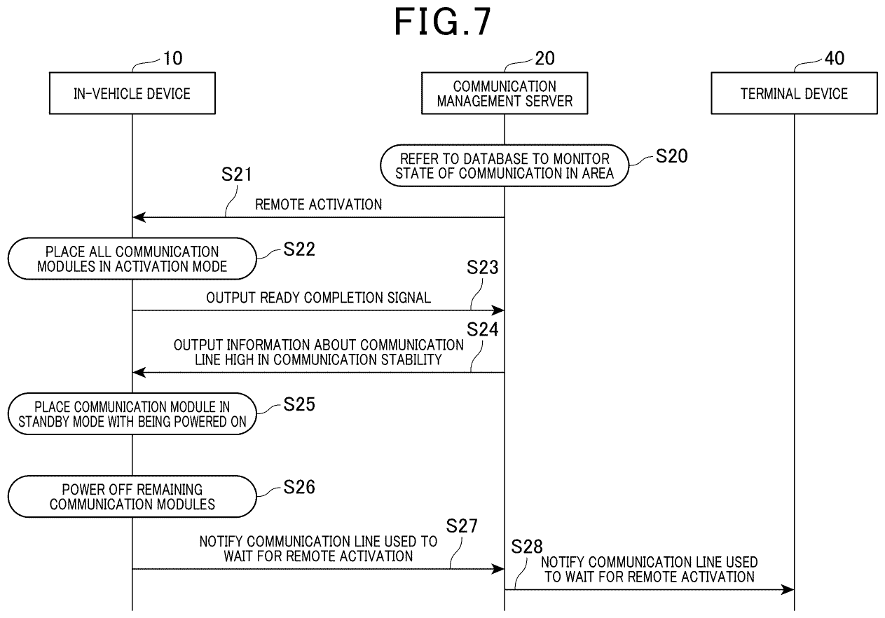

When the state of communication in the activation line has deteriorated, the communication management server 20 outputs a request to the in-vehicle communication device 10 to change the activation line to another in the manner which will be described below with reference to FIG. 7.

The communication state monitor 80 installed in the communication management server 20, as can be seen in FIG. 7, works to refer to the database 30 cyclically to monitor whether one(s) of the in-vehicle communications 10 in which the activation line has been specified is deteriorated in state of communication in the activation line (S20). When the state of communication in the activation line is determined to deteriorate in near future, the remote activator 78 uses the activation line to output a request for changing the activation line to the in-vehicle communication device 10 (S21). As will be described later in detail, all the communication modules 15 are remotely activated.

When receiving the request for changing the activation line, the power supply controller 72 installed in the in-vehicle communication device 10 places all the communication modules 15 in the activation mode (S22) and then outputs a ready completion signal to the communication management server 20. The in-vehicle communication devices 10 are, therefore, remotely activated this time at the discretion of the control center. The activation line candidate output device 76 installed in the communication management server 20 refers to the database 30 to obtain information about one of the communication lines which is high in stability in communication and outputs a signal indicative thereof to the in-vehicle communication device 10 (S24). The in-vehicle communication device 10 is, therefore, notified of a candidate for another activation line.

The power supply controller 72 installed in the in-vehicle communication device 10 determines the specified candidate for the activation line (i.e., the activation line candidate), that is, a selected one of the communication lines which is high in stability in communication as the activation line and keeps one of the communication modules 15 which corresponds or connects with the newly selected activation line powered on and places it in the standby mode (S25). The power supply controller 72 powers off the remaining communication modules 15 and places them in the rest mode (S26). The power supply controller 72 notifies the communication management server 20 of which communication line is used to wait for remotely activating the in-vehicle communication device 10 (S27). Similarly, the communication management server 20 notifies the terminal device 40 of which communication line is used to wait for remotely activating the in-vehicle communication device 10 (S28). The in-vehicle communication device 10 then enters the power-saving mode and waits for remote activation by the communication management server 20.

### Tasks in In-Vehicle Communication Device

Programs performed in each of the in-vehicle communication devices 10 will be described below.

### Standby-Mode Entry Task

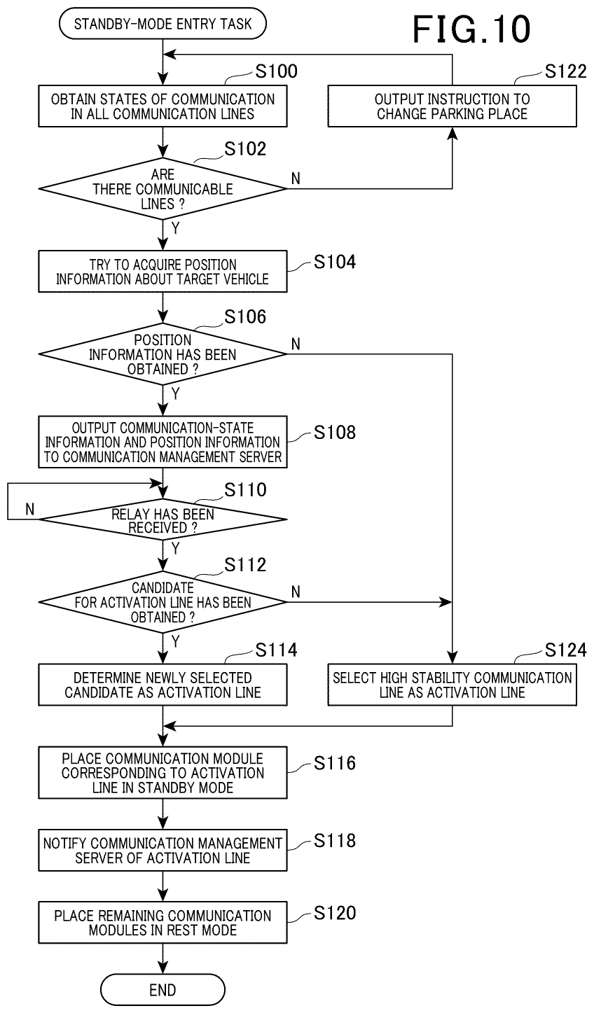

A program to perform the standby-mode entry task will be described below with reference to FIG. 10. The program is executed by the CPU 12A installed in the in-vehicle communication device 10. When the in-vehicle communication device 10 stops moving, the program is initiated.

After entering the program, the routine proceeds to step S100 wherein the CPU 12A obtains the states of communication in all the communication lines. The routine proceeds to step S102 wherein the CPU 12A determines whether there are the communication lines communicable with the communication management server 20. If a YES answer is obtained, then the routine proceeds to step S104. Alternatively, if a NO answer is obtained meaning that there are no available communication lines, then the routine proceeds to step S122. In step S104, the CPU 12A tries to acquire information about the position of the target vehicle from the GPS device 16.

If a NO answer is obtained in step S102 meaning that there are no available communication lines, then the routine proceeds to step S122 wherein an instruction is issued to the target vehicle to change a parking place thereof. The routine then returns back to step S100. When there are no available communication lines, e.g., the target vehicle is out of transmission ranges of all mobile network carriers, it is impossible for the in-vehicle communication device 10 to communicate with the communication management server 20. In a case where the target vehicle is a private passenger vehicle, not a self-driving vehicle, the information processor 12 warns a driver of the target vehicle of the above fact. In a case where the target vehicle is a self-driving or autonomous vehicle, the information processor 12 instructs a vehicle controller installed in the target vehicle to change a parking space.

The routine proceeds to step S106 wherein the CPU 12A determines whether the position information has been obtained from the GPS device 16. If a YES answer is obtained, then the routine proceeds to step S108. Alternatively, if a NO answer is obtained, then the routine proceeds to step S124. In step S108, the CPU 12A controls the operation of the communication device 14 to transmit the communication-state information and the position information to the communication management server 20.

After step S108, the routine proceeds to step S110 wherein the CPU 12A determines whether a reply has been received from the communication management server 20. For instance, when there is no data about an area where the target vehicle is parked in the database 30, it may be impossible for the communication management server 20 to newly select a candidate for the activation line. In such an event, the communication management server 20 notifies the target vehicle of the fact that it is impossible to newly select a candidate for the activation line.

After step S110, the routine proceeds to step S112 wherein the CPU 12A determines whether the newly selected candidate for the activation line has been received from the communication management server 20. If a YES answer is obtained, then the routine proceeds to step S114. Alternatively, if a NO answer is obtained, then the routine proceeds to step S124.

In step S114, the CPU 12A updates the activation line selected until now and determines the newly selected candidate as the activation line. If a NO answer is obtained in step S112 meaning that the newly selected candidate has not yet been obtained, or a NO answer is obtained in step S106 meaning the position information has not been received, then the routine proceeds to step S124 wherein the CPU 12A analyzes the states of communication in all the communication lines, as obtained in step S100, to newly select one of the communication lines which is highest in stability in communication as the activation line.

After step S114 or S124, the routine proceeds to step S116 wherein the CPU 12A places one of the communication modules 15 which corresponds to the newly selected activation line in the standby mode. The routine proceeds to step S118 wherein the CPU 12A notifies the communication management server 20 of the newly selected activation line. The routine proceeds to step 120 wherein the CPU 12A places all the remaining communication modules 15 in the rest mode (i.e., power-off mode). The routine then terminates.

### Activation Task and Communication-Line Change Task

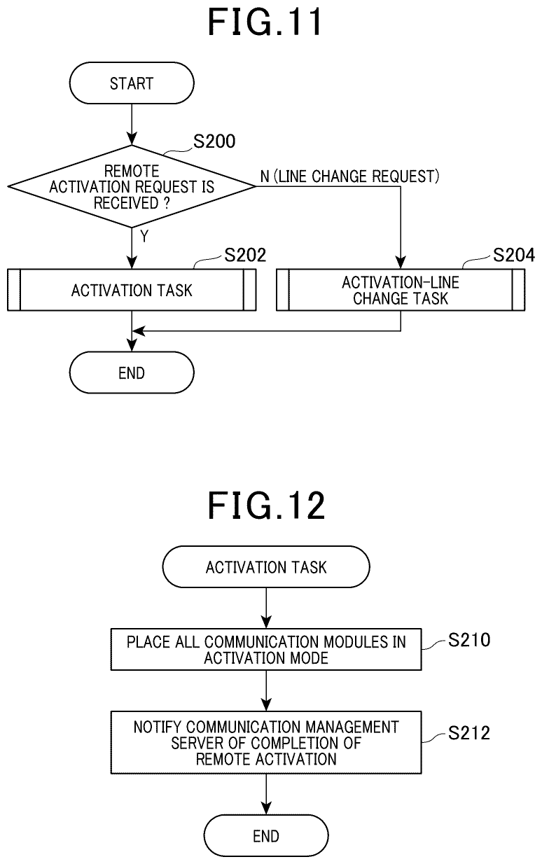

A program performing the activation task and the communication-line change task will be described below with reference to FIG. 11. The CPU 12A installed in the in-vehicle communication device 10 executes the program in response to a trigger signal. Specifically, when receiving the trigger signal, the CPU 12A initiates the program in FIG. 11. Specifically, in step S200, the CPU 12A determines whether the remote activation request has been received. If a YES answer is obtained meaning that the remote activation request has been received, then the routine proceeds to step S202 wherein the activation task is performed. Alternatively, if a NO answer is obtained meaning that a communication-line change request has been received, then the routine proceeds to step S204 wherein an activation-line change task is performed.

A sequence of logical steps performing the activation task will be described below with reference to FIG. 12. Upon entry into step S202 in FIG. 11, the routine proceeds to step S210 wherein the CPU 12A places all the communication modules 15 in the activation mode in response to the activation request (i.e., a power-on request). The routine then proceeds to step S212 wherein the CPU 12A controls the operation of the communication device 14 to transmit a notification about the completion of remote activation of the communication modules 15 to the communication management server 20. The routine then terminates.

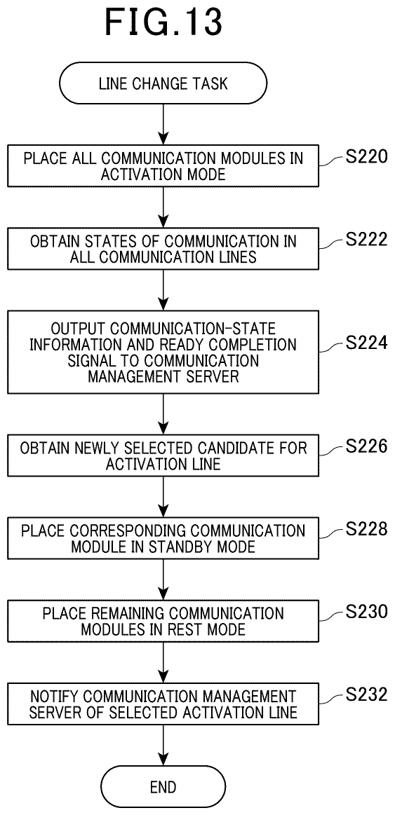

A sequence of logical steps performing the communication-line change task will be described below with reference to FIG. 13. Upon entry into step S204 in FIG. 11, the routine proceeds to step S220 in FIG. 13 wherein the CPU 12A places all the communication modules 15 in the activation mode in response to the communication-line change request. The routine proceeds to step S222 wherein the CPU 12A obtains the states of communication in all the communication lines. The routine proceeds to step S224 wherein the CPU 12A controls the operation of the communication device 14 to output the communication-state information and the ready completion signal to the communication management server 20.

The routine proceeds to step S226 wherein the CPU 12A obtains the newly selected candidate for the activation line (i.e., the activation line candidate) from the communication management server 20. The routine proceeds to step S228 wherein the CPU 12A newly sets the activation line candidate as the activation line and places one of the communication modules 15 which corresponds to the activation line candidate in the standby mode. The routine proceeds to step S230 wherein the CPU 12A places the remaining communication modules 15 in the rest mode. The routine proceeds to step S232 wherein the CPU 12A notifies the communication management server 20 of the newly selected activation line. The routine then terminates.

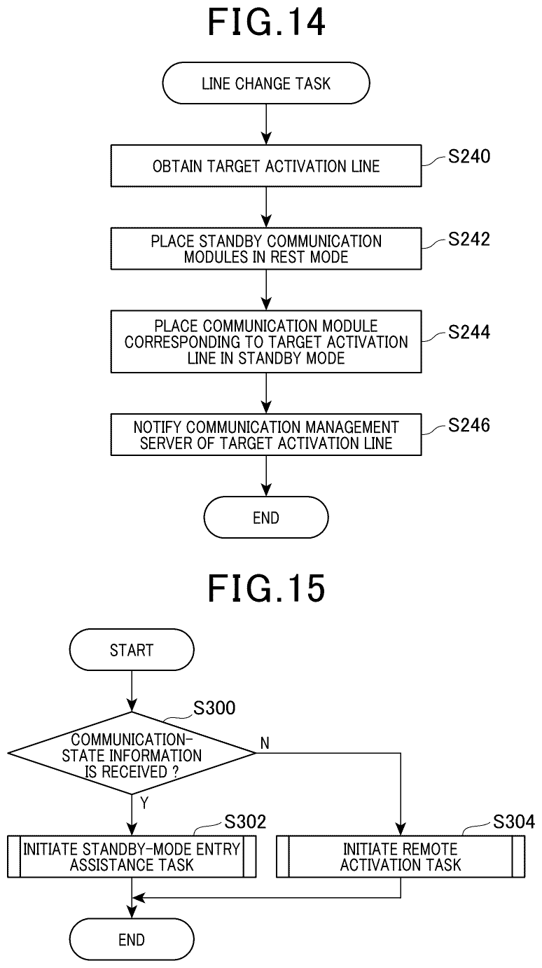

In the example in FIG. 13, when the communication-line change request is made, the in-vehicle communication device 10 obtains the states of communication in all the communication lines and transmit the communication-state information to the communication management server 20. This is for enhancing the usability of the database 30. The communication management server 20 may be designed to specify a target one of the communication lines to which the activation line should be changed and then requests the in-vehicle communication device 10 to change the activation line. This activation line change is achieved according to the communication-line change task illustrated in FIG. 14.

First, in step S240 in FIG. 14, the CPU 12A installed in the in-vehicle communication device 10 obtains a target one (which will also be referred to below as a target activation line) of the communication lines to which the currently selected activation line should be changed. The routine proceeds to step S242 wherein the CPU 12A brings the communication modules 15 which are now in the standby mode to the rest mode. The routine proceeds to step S244 wherein the CPU 12A places one of the communication modules 15 which corresponds to the target activation line in the standby mode. The routine proceeds to step S246 wherein the CPU 12A notifies the communication management server 20 of the newly selected activation line (i.e., the target activation line). The routine then terminates.

### Task in Communication Management Server

Programs executed in the communication management server 20 will be described below. First, a program performing the standby-mode entry assistance task and the remote activation task will be discussed with reference to FIG. 15. The program is initiated in response to reception of a trigger signal. When receiving the trigger signal, the CPU 22A installed in the communication management server 20 initiates the program in FIG. 15. First, in step S300, the CPU 22A determines whether the communication-state information and/or the position information have been received. If a YES answer is obtained meaning that the communication-state information has been received, then the routine proceeds to step S302 wherein the standby-mode entry assistance task is initiated. Alternatively, if a NO answer is obtained meaning that the communication-state information is not yet received and that the activation command from the terminal device 40, then the routine proceeds to step S304 wherein the CPU 22A initiates the remote activation task.

### Standby-Mode Entry Assistance Task

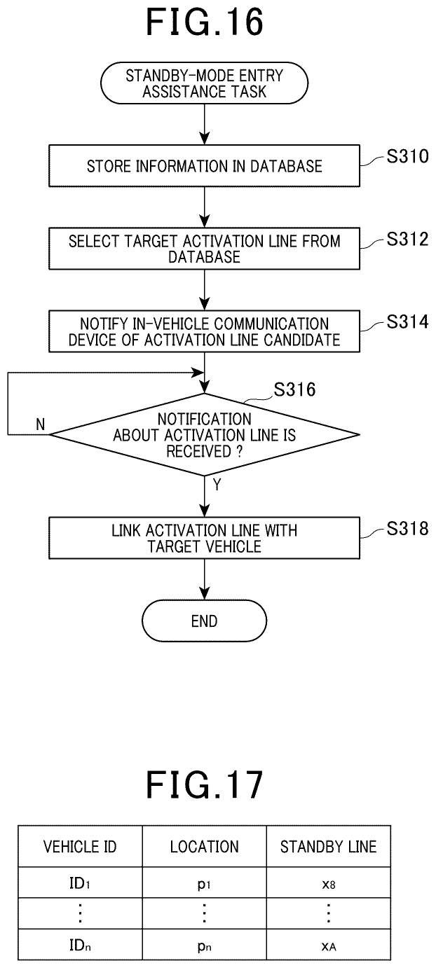

A sequence of steps performing the standby-mode entry assistance task will be described below with reference to FIG. 16. First, in step S310, the CPU 22A receives the communication-state information and the position information, links a combination of the communication-state information and the position information with the time, and then stores it in the database 30. The routine proceeds to step S312 wherein the CPU 22A refers to the database 30 to select the activation line candidate using an area specified by the position information and a present time zone. The routine proceeds to step S314 wherein the CPU 22A controls the operation of the communication device 24 to notify the in-vehicle communication device 10 of the selected activation line candidate. The routine proceeds to step S316 wherein the CPU 22A determines whether a notification about the activation line has been received from the in-vehicle communication device 10. If a YES answer is obtained meaning that the CPU 22A is notified of the activation line, then the routine proceeds to step S318 wherein the activation line of which the CPU 22A is notified is linked to the target vehicle and then stored in a memory. The routine then terminates.

Each vehicle has the single in-vehicle communication device 10 installed therein. The in-vehicle communication devices 10 are, therefore, identified using identification information about the vehicles. The storage device 26 of the communication management server 20 has, for example, an activation line list stored therein in the form of a table. The activation line table, as demonstrated in FIG. 17, lists relations among vehicle identification information (e.g., IDs of the vehicles), parking locations, and standby lines. When receiving a notification of the activation line, the communication management server 20 adds a newly prepared relation to the activation line table. Conversely, when the in-vehicle communication device 10 has been remotely activated, it results in no need for managing the activation line. Such an activation line is, therefore, deleted from the activation line table.

### Remote Activation Task

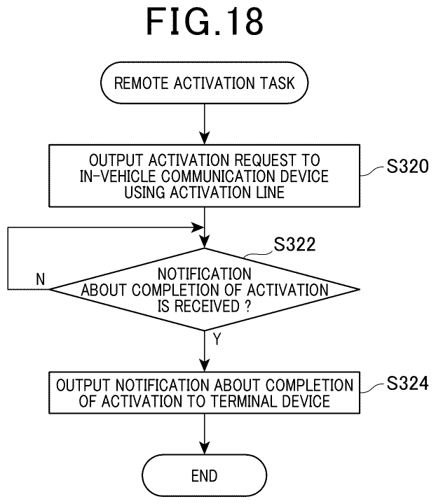

A sequence of logical steps performing the remote activation task will be described below with reference to FIG. 18. First, in step S320, the CPU 22A works to control the operation of the communication device 24 in response to an activation command outputted from the terminal device 40 to output an activation request to the in-vehicle communication device 10 through the activation line. The routine proceeds to step S322 wherein the CPU 22A determines whether a notification of completion of activation has been received from the in-vehicle communication device 10. If a YES answer is obtained, then the routine proceeds to step S324 wherein the CPU 22A controls the operation of the communication device 24 to notify the terminal device 40 of the completion of activation of the in-vehicle communication device 10. The routine then terminates.

### Communication State Monitoring Task

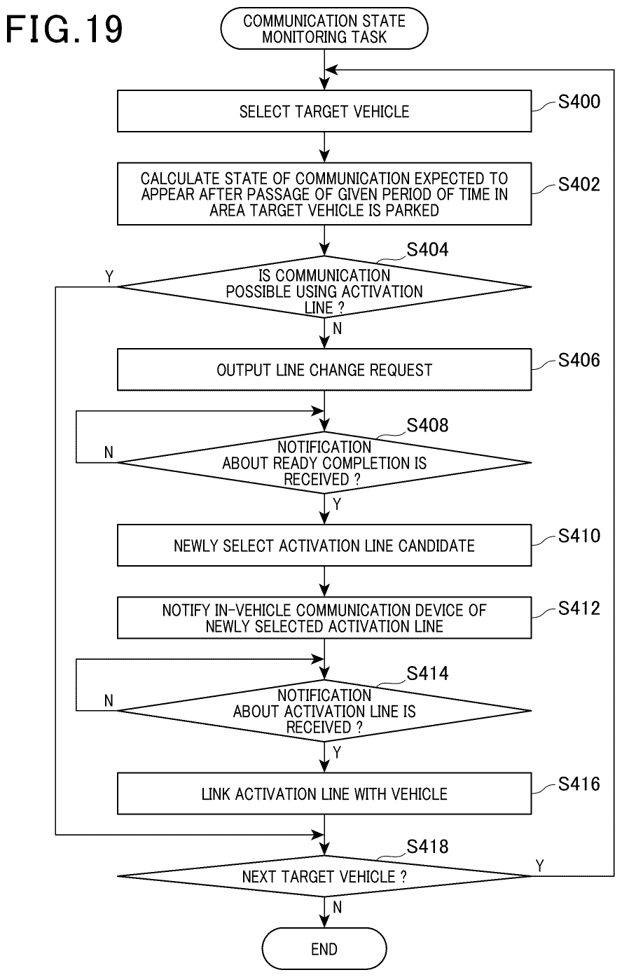

A program performing the communication state monitoring task will be described below with reference to FIG. 19. The program is executed cyclically by the CPU 22A installed in the communication management server 20.

After entering the program, the routine proceeds to step S400 wherein the CPU 22A selects a target one of vehicles from the activation line table. The vehicles and the in-vehicle communication devices 10, as described above, have a one-to-one correspondence with each other. The routine proceeds to step S402 wherein the CPU 22A calculates the state of communication in the activation line in the target vehicle which is expected to appear after a lapse of a given period of time (e.g., one hour) in an area where the target vehicle is parked. The routine proceeds to step S404 wherein the CPU 22A determines whether it is possible to communicate with the communication management server 20 using the activation line. If a NO answer is obtained meaning that it is impossible to communicate with the communication management server 20, then the routine proceeds to step S406. Alternatively, if a YES answer is obtained meaning that there is no need for changing the activation line, then the routine proceeds to step S418.

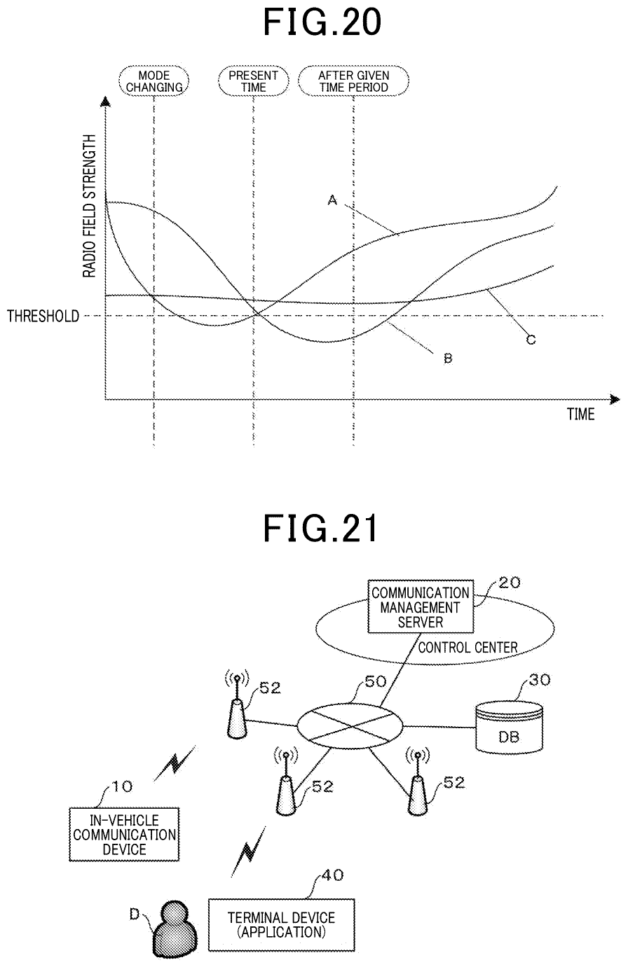

How to determine whether the activation line is now available for achieving communication between each of the in-vehicle communication devices 10 and the communication management server 20 will be described below with reference to FIG. 20. In the illustrated example, the communication lines include three lines: communication lines A, B, and C. A parameter or index representing the state of communication is given by the radio field strength. The radio field strength of each of the communication lines A, B, and C usually varies with time. When the radio field strength is lower than an illustrated threshold level, it is impossible to communicate between the in-vehicle communication device 10 and the communication management server 20. For instance, in a case where there is a target vehicle using the communication line B as the activation line, the radio field strength of the communication line B will be lower than the threshold level after a lapse of a given period of time from the present time. This causes the communication line B not to be used to communicate with the communication management server 20.

Referring back to FIG. 19, if a NO answer is obtained in step S404, then the routine proceeds to step S406 wherein the CPU 22A controls the operation of the communication device 24 to output the communication-line change request to the in-vehicle communication device 10. The routine proceeds to step S408 wherein the CPU 22A determines whether the ready completion signal has been received. If a YES answer is obtained meaning that the ready completion signal is received, then the routine proceeds to step S410 wherein the CPU 22A refers to the database 30 to newly select the activation line candidate, in other words, a target one of the communication lines to which the activation line now used should be changed. The routine proceeds to step S412 wherein the CPU 22A notifies the in-vehicle communication device 10 of the newly selected activation line candidate.

The routine proceeds to step S414 wherein the CPU 22A determines whether a notification about the newly used activation line is received from the in-vehicle communication device 10. If a YES answer is obtained, then the routine proceeds to step S416 wherein the activation line received from the in-vehicle communication device 10 is linked to the target vehicle and then recorded. For instance, rows of the activation line in the activation line table shown in FIG. 17 are updated. The routine proceeds to step S418 wherein the CPU 22A determines whether there is a next one of the vehicles which should be managed as a target vehicle. If a YES answer is obtained, then the routine returns back to step S400. Alternatively, if a NO answer is obtained, then the routine terminates. In this way, the communication management system in this embodiment works to monitor target vehicles in sequence to manage the states of communication in the activation lines used for the target vehicles.

As apparent from the above discussion, each of the in-vehicle communication devices 10 in the first embodiment is placed in the power-saving mode with at least one of the communication modules 15 in which the communication line whose state of communication is acceptable or useful being in the standby mode, thereby ensuring the stability in establishing the remotely activatable mode of the in-vehicle communication device 10. The remaining communication modules 15 are placed in the rest mode, thereby minimizing a total power consumption in the in-vehicle communication devices 10.

The first embodiment is configured to accumulate the communication-state information, as derived from each target vehicle which is parked, in the database 30, thereby obtaining statistical data about the state of communication in each communication line in each in-service area and each time zone (i.e., time period). The communication management server 20 is capable of using the data contained in the database 30 to select an available one of the communication lines which is high in state of communication in a specified area and a specified time zone (i.e., specified time period) at the present time or after a lapse of a given period of time.

The first embodiment is also configured to have each of the in-vehicle communication devices 10 which notifies the communication management server 20 of the available activation line, thereby ensuring the stability in remotely activate each of the in-vehicle communication devices 10 using the available activation line. The communication management server 20 cyclically monitors the state of communication in one of the communication lines that is the activation line now being used in each of the in-vehicle communication devices 10 and, when the state of communication in the activation line has deteriorated, requests the corresponding in-vehicle communication device 10 to change the activation line to another of the communication lines, thereby ensuring the stability in the remotely activatable mode of the in-vehicle communication device 10 despite a variation in state of communication in the communication lines.

### Second Embodiment

A communication management system according to the second embodiment will be described below with reference to FIG. 21. The communication management system in this embodiment is designed to have the database 30 installed in the network 50 to which the in-vehicle communication devices 10 are directly accessible. Other arrangements are identical with those in the first embodiment, and explanation thereof in detail will be omitted here. The database 30 may be implemented by a database server, a file server, or a NAS (Network Attached Storage).

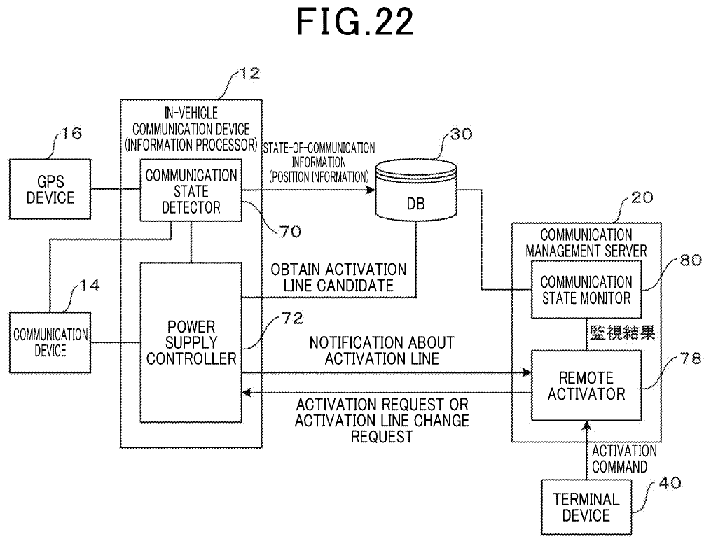

A functional structure of the communication management system will be described below with reference to FIG. 22. Each of the in-vehicle communication devices 10 includes the communication state detector 70 and the power supply controller 72. The communication management server 20 includes the remote activator 78 and the communication state monitor 80. The remote activator 78 and the communication state monitor 80 are identical in function with those in the first embodiment.

The communication state detector 70 works to measure and obtain the states of communication in the plurality of communication lines and the position information about the present position of a target vehicle in which the in-vehicle communication device 10 is installed. The communication state detector 70 also works to store the position information and the communication-state information in the database 30. The power supply controller 72 refers to the database 30 and tries to obtain the activation line candidate to determine the activation line (i.e., an available one of the communication lines). In the power-saving mode, the power supply controller 72 places at least one of the communication modules 15 which connects with the activation line in the standby mode and also places the remaining communication modules 15 in the rest mode (i.e., power-off mode). The power supply controller 72 notifies the communication management server 20 of the activation line which is available.

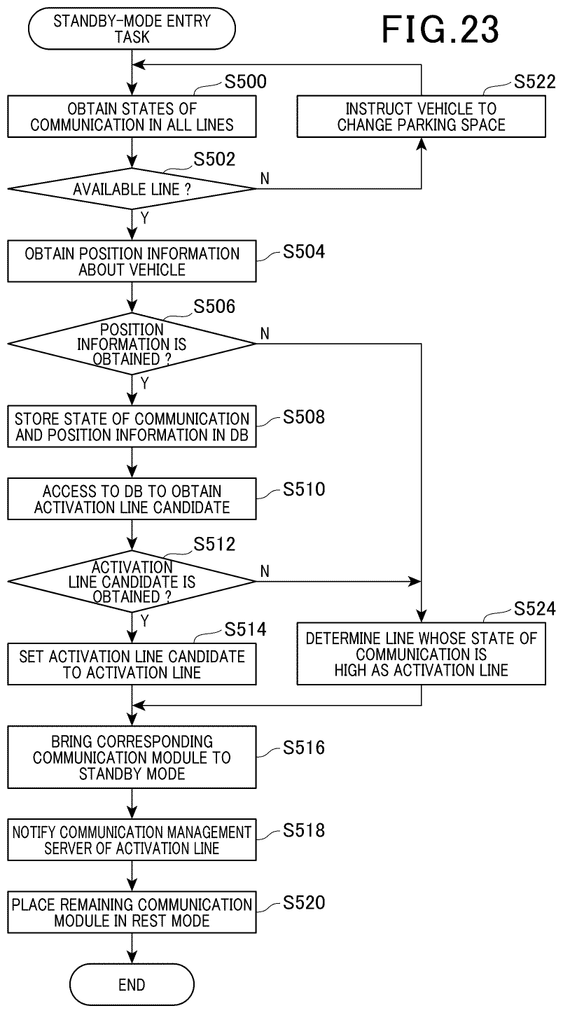

A sequence of logical steps or program executed by each of the in-vehicle communication devices 10 to perform the standby-mode entry task will be described below with reference to FIG. 23. The program in FIG. 23 has steps S508 and S510 instead of steps S108 and S110 in FIG. 10. Other steps are identical with those in FIG. 10, and explanation thereof in detail will be omitted here. If a YES answer is obtained in step S506 (i.e., step S106 in FIG. 10) meaning that the position information about the target vehicle has been obtained, then the routine proceeds to step S508 wherein the CPU 12A controls the operation of the communication device 14 to output the communication-state information and the position information in the form of signals to the database 30. The routine then proceeds to step S510 wherein the CPU 12A accesses directly to the database 30 to obtain the activation line candidate matching an area specified by the position information and a present time zone. The following steps are, as described above, identical with those in FIG. 10.

The second embodiment offers substantially the same beneficial advantages as those in the first embodiment and also has an additional feature that each of the in-vehicle communication devices 10 is capable of accessing directly to the database 30 to obtain the activation line candidate, thereby enabling the in-vehicle communication devices 10 to enter the power-saving mode without waiting for a response from the communication management server 20.

### Third Embodiment

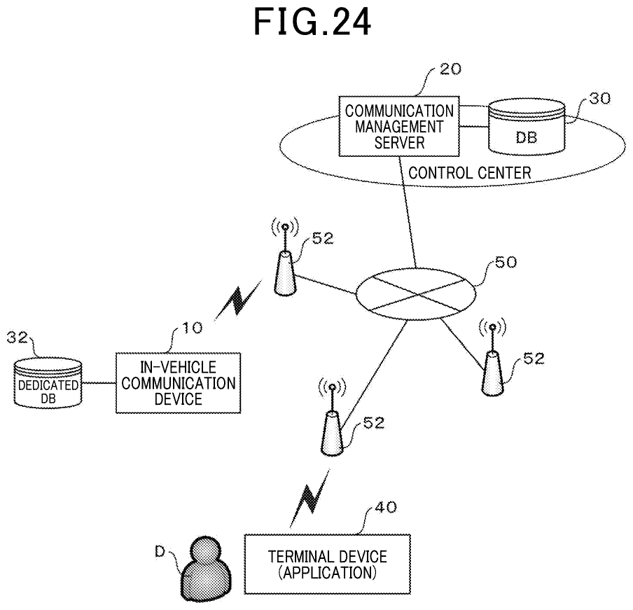

A communication management system in the third embodiment, as illustrated in FIG. 24, has the dedicated database 32 installed in the target vehicle which is separate from the database 30. Other arrangements are identical with those in the first embodiment, and explanation thereof in detail will be omitted here.

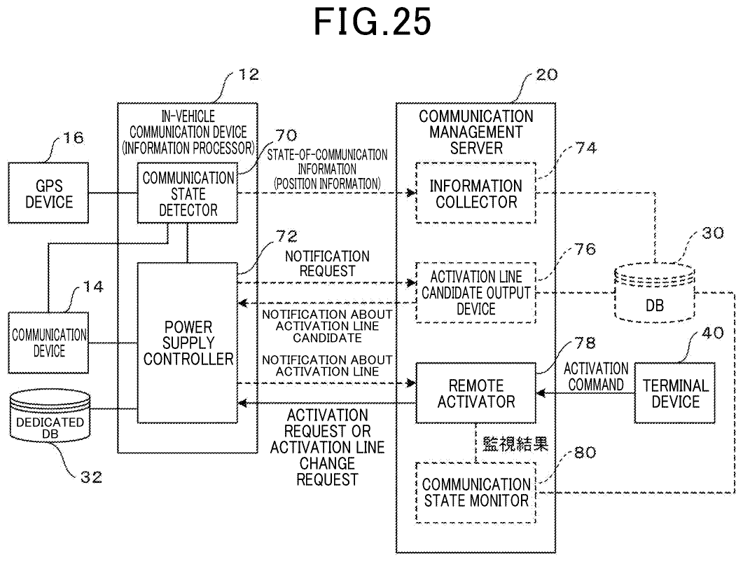

A functional structure of the communication management system in this embodiment will be described with reference to FIG. 25. Each of the in-vehicle communication devices 10 includes the dedicated database 32. The dedicated database 32 may be arranged outside the information processor 22 or installed in the storage device 18 serving as an external storage memory. The dedicated database 32 stores therein the communication-state information and the position information, as obtained by the target vehicle when parked, in relation to a corresponding time zone. The power supply controller 72 of the in-vehicle communication device 10 works to refer to the dedicated database 32 to select the activation line candidate when it temporarily becomes impossible to communicate with the communication management server 20.

When the power-saving mode is entered, the power supply controller 72 places one(s) of the communication modules 15 which connects with the communication line specified by the activation line candidate in the standby mode while placing the remaining communication modules 15 in the rest mode. When the communication with the in-vehicle communication device 10 is restored, the remote activator 78 of the communication management server 20 remotely activates the communication modules 15 of the in-vehicle communication device 10 using all the communication lines.

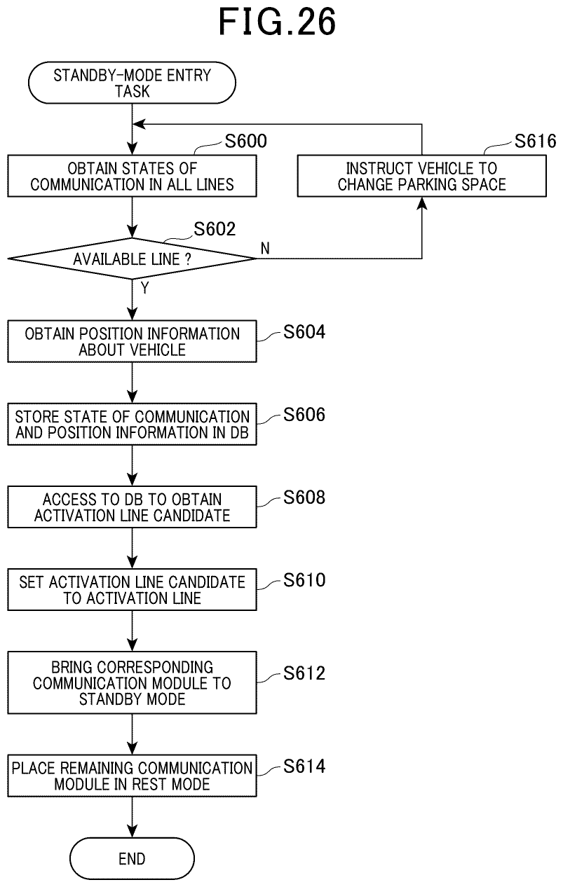

A sequence of logical steps or program executed by each of the in-vehicle communication devices 10 to perform the standby-mode entry task will be described below with reference to FIG. 26. First, in step S600, the CPU 12A obtains the states of communication in all the communication lines. The routine proceeds to step S602 wherein the CPU 12A determines whether each of the communication lines is available in communication with the communication management server 20. If a YES answer is obtained meaning that at least one of the communication lines is available in communication with the communication management server 20, then the routine proceeds to step S604. Alternatively, if none of the communication lines are available in communication with the communication management server 20, then the routine proceeds to step S616 wherein an instruction is issued to the target vehicle to change a parking place. The routine then returns back to step S600. In step S604, the CPU 12A obtains the position information about the target vehicle from the GPS device 16.

The routine proceeds to step S606 wherein the CPU 12A stores the communication-state information and the position information in the dedicated database 32. The routine proceeds to step S608 wherein the CPU 12A refers to the dedicated database 32 to select the activation line candidate matching with an area specified by the position information and a corresponding time zone. The routine proceeds to step S610 wherein the CPU 12A determines one of the communication lines specified by the activation line candidate as the activation line. The routine proceeds to step S612 wherein the CPU 12A places one of the communication modules 15 which corresponds to the activation line in the standby mode. The routine proceeds to step S614 wherein the CPU 12A places the remaining communication modules 15 in the rest mode. The routine then terminates.

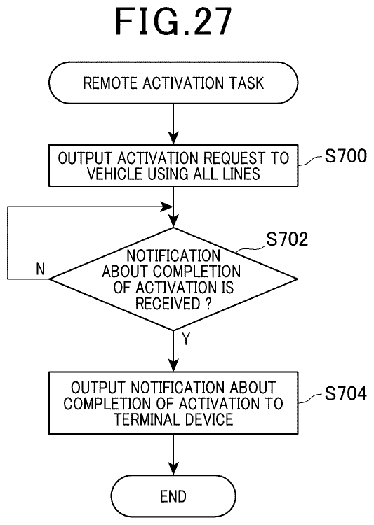

A sequence of logical steps or program executed by the communication management server 20 to perform the remote activation task will be described below with reference to FIG. 27. First, in step S700, the CPU 22A is responsive to an activation command outputted from the terminal device 40 to control the operation of the communication device 24 to output an activation request to a selected one of the in-vehicle communication devices 10 using all the communication lines. The routine proceeds to step 702 wherein the CPU 22A determines whether a notification about completion of activation has been received from a corresponding one of the in-vehicle communication devices 10. If a YES answer is obtained, then the routine proceeds to step 704 wherein the CPU 22A controls the operation of the communication device 24 output the notification about completion of activation to the terminal device 40. The routine then terminates.

The third embodiment offers substantially the same beneficial advantages when the communication is available between a selected one of the in-vehicle communication devices 10 and the communication management server 20 and is also capable of referring to the dedicated database 32 installed in the target vehicle to select the activation line candidate to determine an available one of the communication lines as the activation line to establish the power-saving mode when the communication is not available with the communication management server 20. When it is impossible for the communication management server 20 to determine which communication line is available as the activation line, the activation of each of the in-vehicle communication devices 10 is achieved by transmit an activation request to a corresponding one of the in-vehicle communication devices 10 through all the communication lines.

### Modifications

While this disclosure has referred to the preferred embodiments, it should be appreciated that the disclosure is not limited to the embodiments. This disclosure may include a variety of combinations of the embodiments, a combination of diverse modifications of the embodiments and equivalents thereof.

For instance, the above embodiments may be combined in a required way.

Each of the above embodiments has referred to the example where there may be the plurality of activation lines. In a case where two or more of the communication lines are available as the activation lines, priorities may be set to the activation lines. For instance, the communication management server 20 may be designed to analyze records of the states of communication in the communication lines stored in, for example, the database 30 to determine one of the communication lines which is highest in stability in communication between a corresponding one of the in-vehicle communication devices 10 and the communication management server 20 as the activation line and output an activation request to the corresponding in-vehicle communication device 10 using that activation line. Alternatively, the communication management server 20 may select one of the communication lines which is highest in rate of communication as the activation line and output an activation request to the corresponding in-vehicle communication device 10 using that activation line.

Each of the above embodiments has referred to the example where each of the in-vehicle communication devices 10 obtains information about the activation line candidate that is one of the communication lines which is highest in stability in communication from the database 30 directly or through the communication management server 20, but however, such information may be derived from another control center using a vehicle-to-vehicle communication (V2V) system or a mesh communication network.

For instance, the steps of each of the above-described programs may be altered in sequence, partially omitted, or have an additional step(s) without departing from the purpose of the disclosure. Each of the above embodiments is designed to use a software structure to perform the control tasks in the computer, but however, the control tasks may be performed using a hardware structure or a combination of software and hardware structures.

Each of the above embodiments may be modified to execute the above-described programs using processors instead of the CPUs 12A and 22A. For instance, the processors may be implemented by PLDs (Programmable Logic Devices), such as FPGAs (Field-Programmable Gate Arrays) which have reconfigurable digital circuits after they are manufactured. Each of the processors may alternatively be designed to have an electrical circuit, such as an ASIC (Application-Specific Integrated Circuit), customized for a particular use.

Each of the above programs may be executed using only one or two or more (e.g., FPGAs or a combination of a CPU and an FPGA) of all possible different types of processors. Such processors may be realized by electrical circuits fabricated using semiconductor devices.

Each of the above embodiments is configured to have the programs which are installed in the storage devices, but however, may alternatively be installed in a non-transitory memory, such as a CD-ROM (Compact Disk Read Only Memory), a DVD-ROM (Digital Versatile Disk Read Only Memory), a USB (Universal Serial Bus) memory, or a semiconductor memory. The programs may also be downloaded from an external device using a network.

What is claimed is:

1. An in-vehicle communication device for use with a target vehicle comprising:
a communication device which includes a plurality of communication modules each for a respective one of a plurality of discrete communication lines; and
a power supply controller which, when the target vehicle is stopped, works to analyze states of communication in the communication lines to select at least one of the communication lines which is available as an activation line used for remote activation of the in-vehicle communication device made by a communication management server, the power supply controller also working to place a target communication module that is one of the communication modules which corresponds to the activation line in a standby mode in which the target communication module is kept powered on and enabled only to receive a request signal from the communication management server, the power supply controller also placing the remaining communication modules other than the target communication module in a rest mode in which the remaining communication modules are kept powered off.

2. The in-vehicle communication device as set forth in claim 1, wherein a degree of stability in state of communication in the activation line is higher than those in the communication lines other than the activation line.

3. The in-vehicle communication device as set forth in claim 2, wherein the degree of stability in state of communication is given by a parameter representing one of a radio field strength, congestion, throughput, and latency.

4. The in-vehicle communication device as set forth in claim 1, wherein the power supply controller works to notify the communication management server of the activation line in advance.

5. The in-vehicle communication device as set forth in claim 1, wherein the power supply controller is responsive to an activation request received from the communication management server through the activation line to supply electrical power to all the communication modules to bring all the communication modules to an activation mode in which data communication is available.

6. The in-vehicle communication device as set forth in claim 1, wherein the power supply controller is responsive to a communication-line change request, as received from the communication management server using the activation line, to change the activation line to a second activation line that is one of the communication lines and places one of the communication modules which corresponds to the second activation line in the standby mode, while placing the remaining communication modules in the reset mode.

7. The in-vehicle communication device as set forth in claim 1, wherein the power supply controller uses information to determine the activation line, the information being received from outside the in-vehicle communication device and representing an activation line candidate that is one of the communication lines which is higher in state of communication than the other.

8. The in-vehicle communication device as set forth in claim 7, wherein the information representing the activation line candidate is obtained from an external database directly or through the communication management server, the external database storing therein data representing states of communication in the communication lines in each area and in each time period.

9. The in-vehicle communication device as set forth in claim 1, further comprising a communication state detector which works to detect states of communication in the communication lines made by the communication device, and wherein
the power supply controller analyzes the states of communication derived by the communication state detector to determine the activation line.

10. The in-vehicle communication device as set forth in claim 9, wherein in response to the information representing the activation line candidate being not received from outside, the power supply controller determines the activation line using the states of communication derived by the communication state detector.

11. The in-vehicle communication device as set forth in claim 9, wherein the communication state detector obtains position information about the target vehicle along with communication-state information that is information about the states of communication and stores the communication-state information and the position information directly or through the communication management server in an external database in which information representing the states of communication in the communication lines is retained in relation to each area and each time period.

12. The in-vehicle communication device as set forth in claim 11, wherein the power supply controller is responsive to the communication-line change request, as received from the communication management server, to power on the communication modules to bring the communication modules in the activation mode,
the communication state detector works to measure states of communication in the communication lines again and store them in the external database.

13. A communication management server for an in-vehicle communication device which includes,
a communication device which includes a plurality of communication modules each for a respective one of a plurality of discrete communication lines, and
a power supply controller which, when a target vehicle is stopped, works to analyze states of communication in the communication lines to select at least one of the communication lines which is available as an activation line used for remote activation of the in-vehicle communication device, the power supply controller also working to place a target communication module that is one of the communication modules which corresponds to the activation line in a standby mode in which the target communication module is kept powered on and enabled only to receive an activation request signal, the power supply controller also placing the remaining communication modules other than the target communication module in a rest mode in which the remaining communication modules are kept powered off,
the communication management server comprising:
an output device which outputs an activation line candidate to the in-vehicle communication device, the activation line candidate being a candidate for the activation line and representing one of the communication lines which is higher in stability in state of communication than the other; and
a remote activator which transmits the activation request signal using the activation line to remotely activate the in-vehicle communication device.

14. The communication management server as set forth in claim 13, wherein the degree of stability in state of communication is given by a parameter representing one of a radio field strength, congestion, throughput, and latency.

15. The communication management server as set forth in claim 13, wherein the output device refers to an external database to determine the activation line candidate using position information about the target vehicle and a time at which the target vehicle is pared, the database storing states of communication in the communication lines in relation to each area and each time period.

16. The communication management server as set forth in claim 13, wherein the remote activator stores in a storage the activation line sent from the in-vehicle communication device and then reads information about the activation line from the storage when activating the in-vehicle communication device.

17. The communication management server as set forth in claim 13, further comprising a communication state monitor which monitors a state of communication in the activation line, and wherein
when it is determined based on a result of monitoring made by the communication state monitor that the state of communication in the activation line is expected to drop after a lapse of a given period of time, the remote activator outputs a communication-line change request using the activation line to request the in-vehicle communication line to change the activation line now used.

18. The communication management server as set forth in claim 17, wherein the communication state monitor works to analyze information, as stored in an external database, which represents possible states of communication in the communication lines after the lapse of the given period of time in an area where the target vehicle is stopped to predict a drop in state of communication in the activation line after the lapse of the given period of time, the database storing states of communication in the communication lines in relation to each area and each time period.

19. The communication management server as set forth in claim 17, wherein when a parameter indicating a state of communication in the activation line has dropped to be lower than or equal to a preselected threshold, the remote activator outputs the communication-line change request.

20. The communication management server as set forth claim 13, further comprising an information collector which collects the communication-state information and the position information from the in-vehicle communication device and stores them in an external database in which states of communication in the communication lines are stored in relation to each area and each time period.

21. A program which causes a computer, as installed in an in-vehicle communication device which is mounted in a target vehicle and includes a plurality of communication modules each for a respective one of a plurality of communication lines, to function as:
a power supply controller which, when the target vehicle is stopped, works to analyze states of communication in the communication lines to select at least one of the communication lines which is available as an activation line used for remote activation of the in-vehicle communication device made by a communication management server, the power supply controller also working to place a target communication module that is one of the communication modules which corresponds to the activation line in a standby mode in which the target communication module is kept powered on and enabled only to receive a request signal from the communication management server, the power supply controller also placing the remaining communication modules other than the target communication module in a rest mode in which the remaining communication modules are kept powered off.

22. A program which is executed by a computer, as installed in a communication management server designed to manage an operation of an in-vehicle communication device which includes,
a communication device which includes a plurality of communication modules each for a respective one of a plurality of discrete communication lines, and
a power supply controller which, when a target vehicle is stopped, works to analyze states of communication in the communication lines to select at least one of the communication lines which is available as an activation line used for remote activation of the in-vehicle communication device made by a communication management server, the power supply controller also working to place a target communication module that is one of the communication modules which corresponds to the activation line in a standby mode in which the target communication module is kept powered on and enabled only to receive a request signal from the communication management server, the power supply controller also placing the remaining communication modules other than the target communication module in a rest mode in which the remaining communication modules are kept powered off,
the program causes the computer to function as:
an output device which outputs an activation line candidate to the in-vehicle communication device, the activation line candidate being a candidate for the activation line and representing one of the communication lines which is higher in stability in state of communication than the other; and
a remote activator which transmits an activation request using the activation line to remotely activate the in-vehicle communication device.

23. A communication management system comprising:
(a) an in-vehicle communication device which includes,
a communication device which includes a plurality of communication modules each for a respective one of a plurality of discrete communication lines, and
a power supply controller which, when the target vehicle is stopped, works to analyze states of communication in the communication lines to select at least one of the communication lines which is available as an activation line used for remote activation of the in-vehicle communication device, the power supply controller also working to place a target communication module that is one of the communication modules which corresponds to the activation line in a standby mode in which the target communication module is kept powered on and enabled only to receive an activation request, the power supply controller also placing the remaining communication modules other than the target communication module in a rest mode in which the remaining communication modules are kept powered off; and
(b) the communication management server which is communicable with the in-vehicle communication device using a network and includes,
an output device which outputs an activation line candidate to the in-vehicle communication device, the activation line candidate being a candidate for the activation line and representing one of the communication lines which is higher in stability in state of communication than the other, and
a remote activator which transmits the activation request signal using the activation line to achieve the remote activation of the in-vehicle communication device.

24. The communication management system as set forth in claim 23, further comprising an external database which is connected to be communicable with at least one of the communication management server and the in-vehicle communication device and stores therein sates of communication in the communication lines in relation to each area and each time period.

25. A communication management method comprising:
outputting a signal to an in-vehicle communication device installed in a target vehicle from a communication management server communicable with the in-vehicle communication device using a network, the in-vehicle communication device including a communication device equipped with a plurality of communication modules each for a respective one of a plurality of discrete communication lines, the signal indicating at least one of the communication lines which is higher in stability in state of communication than the other;
analyzing the signal, when the target vehicle is stopped, to determine the at least one of the communication lines which is higher in stability in state of communication than the other as an activation line used for remote activation of the in-vehicle communication device made by the communication management server;
placing a target communication module that is one of the communication modules which corresponds to the activation line in a standby mode in which the target communication module is kept powered on and enabled only to receive an activation request from the communication management server;
placing the remaining communication modules other than the target communication module in a rest mode in which the remaining communication modules are kept powered off; and
outputting the activation request through the communication management server to the in-vehicle communication device using the activation line to achieve the remote activation of the in-vehicle communication device.
